(19) United States
(12) Patent Application Publication
(10) Pub. No.: US 2022/0375069 A1
(43) Pub. Date: Nov. 24, 2022

(54) Estimating Oocyte Quality

(71) Applicant: Embryonics LTD, Bet Shemesh (IL)

(72) Inventors: David H. Silver, Haifa (IL); Avital Luba Polsky, Tel Aviv (IL); Yael Gold-Zamir, Bet Shemesh (IL); Oriel Perl, Tel Aviv (IL)

(21) Appl. No.: 17/323,809

(22) Filed: May 18, 2021

(51) Int. Cl. G06T 7/00; G01N 15/14

(52) U.S. Cl. CPC G06T 7/0012; G01N 15/1475; G01N 2015/1087

(57) ABSTRACT

The present invention extends to methods, systems, and computer program products for estimating oocyte quality. A machine learning algorithm accesses oocyte training data for a mammalian species (e.g., humans) and trains a neural network to estimate oocyte quality for the mammalian species based on the oocyte training data. The neural network accesses a microscopic image of an oocyte and identifies oocyte features of the oocyte. Based on the identified oocyte features, the neural network estimates oocyte quality, including: (a) predicting a probability of a corresponding embryo maintaining sufficient developmental competence until a specified time after fertilization and (b) predicting another probability of the corresponding embryo reaching a specific embryonic stage after fertilization. An oocyte is selected, from among a plurality of human oocytes including the human oocyte, for a potential recipient based at least in part on the oocyte quality, including based on the probability and the other probability.

### TECHNICAL FIELD

The present disclosure relates generally to estimating oocyte quality. Aspects include a data-driven system trained to estimate mammalian (including human) oocyte quality from oocyte imaging files.

### BACKGROUND

The process of fertilizing a human egg outside the body to create an embryo is known as in vitro fertilization (IVF). An embryo created outside the body can then be transferred to a female human, with the desired outcome being pregnancy. IVF is a common technique used to help those suffering from infertility to conceive. IVF is highly effective relative to other assisted reproductive technology (ART) techniques.

As part of an IVF process, multiple embryos are typically created. Among multiple created embryos, some embryos may exhibit characteristics more likely to lead to pregnancy and other embryos may exhibit characteristics less likely to lead to pregnancy. Prior to transfer, trained personnel can select “the best” embryo(s), from among the multiple embryos for transfer. Embryo selection is typically a highly manual process that lacks any universally accepted and standardized criteria.

More specifically, oocytes can be harvested from an adult female and fertilized by live sperm in vitro. Successful fertilization, embryo development, and clinical outcome depend to some extent on oocyte quality. Various aspects of oocyte morphology can be visually inspected by humans to determine developmental potential. Oocytes with increased developmental potential can be fertilized.

After successful fertilization, the resulting embryos are incubated for several days while a trained embryologist manually tracks their development. The embryologist may use morphological and/or morphokinetic characteristics to generate a grade for each embryo. An embryo grade is indicative of the embryo's viability and likelihood of successful uterine implantation, and hopefully live birth. Embryos with higher grades can be selected over embryos with lower grades for transfer to a patient.

### BRIEF DESCRIPTION OF THE DRAWINGS

The specific features, aspects and advantages of the present invention will become better understood with regard to the following description and accompanying drawings where:

FIGS. 1A and 1B illustrate an example computer architecture that facilitates estimating oocyte quality and selecting an oocyte for fertilization.

FIG. 2 illustrates a flow chart of an example method for estimating oocyte quality and selecting an oocyte for fertilization.

FIG. 3 illustrates an example computer architecture that facilitates training a neural network to estimate oocyte quality.

FIG. 4 illustrates an example block diagram of a computing device.

### DETAILED DESCRIPTION

The present invention extends to methods, systems, and computer program products for estimating mammalian (including human) oocyte quality. Aspects include a data-driven system trained to estimate oocyte quality from an imaging file of the oocyte, for example, a microscopic image.

Manual morphological annotation and quality assessment of human oocytes can be used for predicting in vitro fertilization (IVF) success. However, manual assessment can be highly variable between observers. As such, human subjectivity is introduced into human oocyte grading and the selection process.

Various morphological characteristics can be manually observed/assessed to determine human oocyte quality. These characteristics may include assessment of the cytoplasm, zona pellucida, polar body, meiotic spindle, vacuoles or refractile bodies, perivitelline space, etc. under a microscope. Various clinical endpoints have been used for different scoring techniques. However, there is limited, if any, standardization with respect to which endpoints correspond to oocyte quality.

To increase objectivity, some techniques have turned to identification of potential biomarkers, including using genomics, proteomics, and/or metabolomics. However, techniques using biomarkers are relatively time-consuming and potentially expensive as they utilize biological samples (e.g., cumulus cells, follicular fluid, spent culture media, etc.) and special equipment for conducting the analyses (e.g., qRT-PCR, microarrays, spectrometers, ELISA readers, etc.).

Other approaches have utilized artificial intelligence to analyze and classify images. Some algorithms report better performance than morphological assessment by embryologists. However, these other approaches use relatively small sample sizes of test/validation datasets and lack external validation (e.g., no images acquired from additional clinics). Thus, claims made with respect to these other techniques are difficult to verify.

Some of these other approaches are fairly automated, requiring little more that upload of a single image. However, limited specific morphological characteristics are extracted from the image and may require subsequent oocyte measurements by an embryologist. In one approach, a micropipette is used to obtain measurements used at input to the algorithm. However, with no consensus linking morphological characteristics to clinical outcomes, these approaches are potentially quite limiting.

Accordingly, aspects of the invention include estimating oocyte quality for oocytes of virtually any mammalian species, including humans.

A machine learning algorithm accesses oocyte training data for a mammalian species (e.g., humans) and trains a neural network to estimate oocyte quality for the mammalian species based on the oocyte training data. Per oocyte, the training data can include oocyte features from an image of the oocyte and labels indicative of known outcomes from fertilization of the oocyte. The training data can include oocyte features and labels for a plurality of (e.g., hundreds, thousands, tens of thousands, etc.) oocytes of the mammalian species. Training data and known outcomes can be species specific. For humans, known outcomes can include successful fertilization, development of the fertilized oocyte (preimplantation embryo) to various times T after fertilization (e.g., where 0 hours<T<140 hours), progression to a specific embryonic stage (e.g., 2-cell, 4-cell, 8-cell, morula, early blastocyst, blastocyst, etc.), biochemical pregnancy, clinical pregnancy, or live birth.

The machine learning algorithm can train a neural network to consider/utilize a variety of morphological characteristics of the oocyte that may include the shape, integrity, or size of the polar body, meiotic spindles, thickness or birefringence of the zona pellucida, overall appearance of the cumulus complex, shape and/or volume of the oocyte, size and granulation of the perivitelline space, etc. Quality assessment parameters can be varied per mammalian species.

In general, using the trained neural network to estimate oocyte quality can increase the effectiveness of oocyte quality assessment relative to manual assessment and corresponding automated approaches.

An image, set of images, or video of an oocyte (of the appropriate mammalian species) can be supplied to the trained neural network as input. In one aspect, the oocyte source's (e.g., mother or donor) clinical characteristics can be considered in conjunction with the image, set of images, or video. The neural network can estimate quality of the oocyte. The neural network essentially determines correlation between features of the newly considered oocyte and features corresponding to other oocytes considered during initial or subsequent training. The neural network then estimates an oocyte quality based on outcomes associated with other oocytes having similar oocyte features. In one aspect, the oocyte source's clinical characteristics are also considered when estimating oocyte quality.

The determined oocyte quality can include one or more developmental competence probability values and one or more stage probability values. In general, each developmental competence probability value indicates the probability of a corresponding fertilized oocyte (embryo) being developmentally competent until a specified time after fertilization. Relevant time intervals and/or time ranges associated with embryo developmental competence can vary per mammalian species. For example, for humans, there can be a developmental competence probability value corresponding to each day from 0 to 5 days after fertilization. In general, each stage probability value can indicate the probability of an embryo reaching a specific developmental stage after the oocyte is fertilized, or a certain clinical stage after embryo transfer. Developmental stages of embryos can vary per mammalian species. For example, for humans, embryonic stages can include 2-cell, 4-cell, 8-cell, morula, early blastocyst, blastocyst, etc.

In general, oocytes having increased probabilities of longer-term developmental competence and increased probabilities of reaching later developmental and clinical stages can be considered higher quality oocytes. On the other hand, oocytes with decreased probabilities of longer-term developmental competence and/or decreased probabilities of reaching later developmental or clinical stages can be considered lower quality oocytes.

In one aspect, oocyte quality can be given a grade. For example, a trained neural network can assign oocytes a quality grade in a range from 1-5. A larger number indicates a higher quality oocyte and a lower number indicates a lower quality oocyte. However, other ranges and/or grading mechanisms can also be used. In one aspect, a lower number indicates a higher quality oocyte and a higher number indicates a lower quality oocyte.

Aspects of the invention can use oocyte imaging files (e.g., a single image or a series of images acquired from a microscope or a video file acquired with a time-lapse imaging system) as model input allowing a neural network to learn oocyte morphological features.

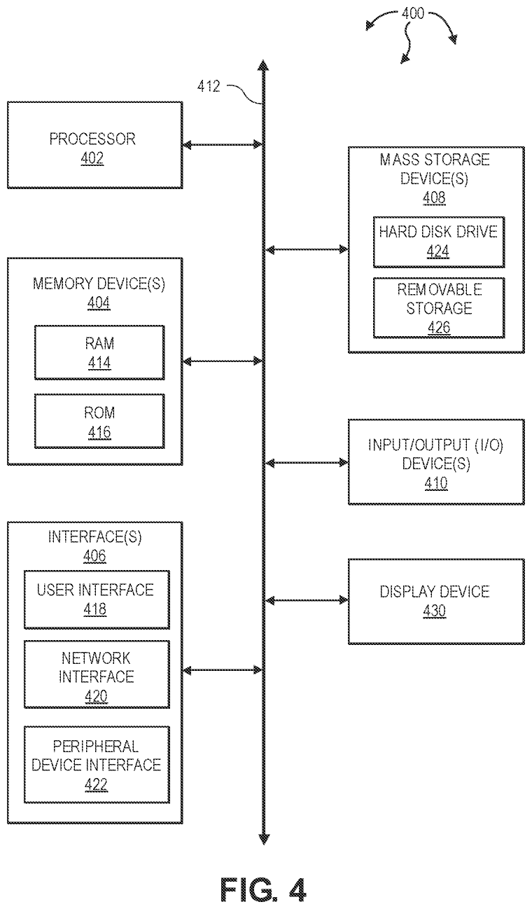

Turning initially to FIG. 4, FIG. 4 illustrates an example block diagram of a computing device 400. Computing device 400 can be used to perform various procedures, such as those discussed herein. Computing device 400 can function as a server, a client, or any other computing entity. Computing device 400 can perform various communication and data transfer functions as described herein and can execute one or more application programs, such as the application programs described herein. Computing device 400 can be any of a wide variety of computing devices, such as a mobile telephone or other mobile device, a desktop computer, a notebook computer, a server computer, a handheld computer, tablet computer and the like.

Computing device 400 includes one or more processor(s) 402, one or more memory device(s) 404, one or more interface(s) 406, one or more mass storage device(s) 408, one or more Input/Output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer storage media, such as cache memory.

Memory device(s) 404 include various computer storage media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer storage media, such as magnetic tapes, magnetic disks, optical disks, solid state memory (e.g., Flash memory), and so forth. As depicted in FIG. 4, a particular mass storage device is a hard disk drive 424. Various drives may also be included in mass storage device(s) 108 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, barcode scanners, microphones, monitors or other display devices, speakers, printers, network interface cards, modems, cameras, lenses, radars, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments as well as humans. Example interface(s) 406 can include any number of different network interfaces 420, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 418 and peripheral device interface 422.

Bus 412 allows processor(s) 402, memory device(s) 404, interface(s) 406, mass storage device(s) 408, and I/O device(s) 410 to communicate with one another, as well as other devices or components coupled to bus 412. Bus 412 represents one or more of several types of bus structures, such as a system bus, PCI bus, IEEE 1394 bus, USB bus, and so forth.

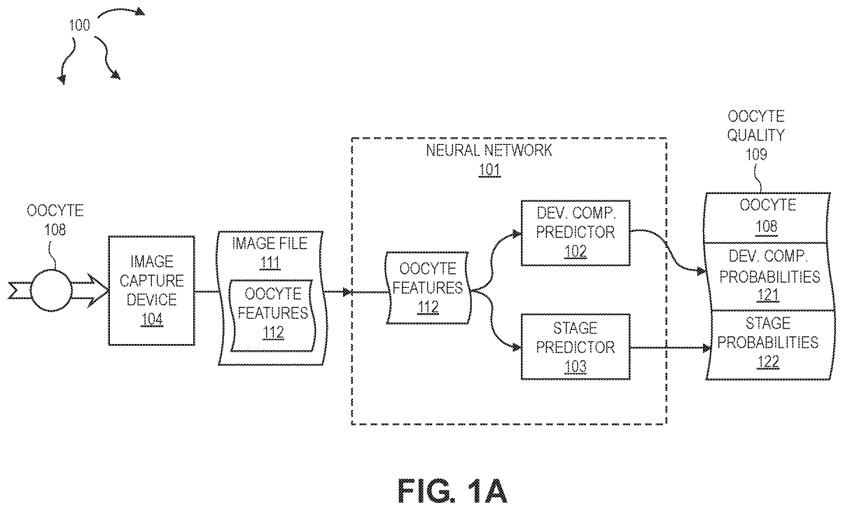

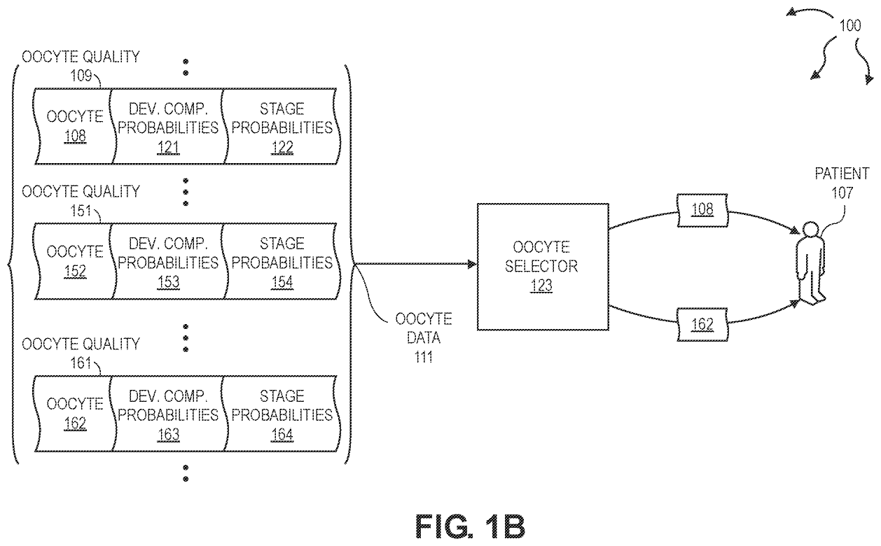

Returning back to FIGS. 1A and 1B, FIGS. 1A and 1B illustrate an example computer architecture 100 that facilitates estimating oocyte quality and selecting an oocyte for fertilization. As depicted, computer architecture 100 includes neural network 101 and image capture device 104. Neural network 101 further includes developmental competence predictor 102 and stage predictor 103.

Image capture device 104 can include a camera for capturing still images and/or capturing video. Image capture device 104 can be included in another device or apparatus, such as, for example, in a microscope or an incubator. Image capture device 104 can be configured and/or positioned to capture images and/or video of oocytes. In one aspect, image capture device 104 captures a set of images depicting a human oocyte. The set of images can be a set of time-lapse images. The set of images can (e.g., collectively) depict morphological features of a human oocyte and/or morphokinetics of the human oocyte.

In general, neural network 101 can access an imaging file or a set of imaging files of an oocyte and estimate a corresponding oocyte quality. Neural network 101 can correlate the image(s) of the oocyte with images of other oocytes (used during training), including identifying other oocytes having features similar to the oocyte. Developmental competence predictor 102 can consider correlation in view of embryo developmental competence at various time frames (e.g., days, weeks, months, etc.) after fertilization. Stage predictor 103 can consider correlation of the probability of viability at different developmental stages after fertilization and/or clinical stages after embryo transfer.

Developmental competence predictor 102 is configured to derive one or more developmental competence probability values corresponding to an oocyte. Each developmental competence probability value represents a probability of a corresponding embryo (or fetus) being developmentally competent until a specified time after oocyte fertilization and/or embryo transfer. In one aspect, for humans, development competence predictor 102 derives a health probability value for each of the first 5 days after fertilization. That is, developmental competence predictor 102 calculates a developmental competence value for the corresponding embryo being developmentally competent until a day after fertilization, a probability value for the corresponding embryo remaining developmentally competent until two days after fertilization, . . . , etc.

Across all mammalian species, gestation varies from around 12 days to around 22 months. As such, health predictor 102 can also be configured (e.g., during training) to calculate health probability values over other relevant and/or appropriate time durations (e.g., 1 day, 2 days, 3 days, 4 days, 7 days, 14 days, 3 weeks, 5 weeks, 10 weeks, 15 weeks, 20 weeks, 6 months, 9 months, 12 months, etc.) and/or other relevant and/or appropriate time increments/intervals (e.g., every hour, every three hours, every day, every two days, every four days, every week, every other week, every month, etc.) tailored to a specific mammalian species.

Combinations of different time durations and increments are also possible. For example, developmental competence predictor 102 can be configured (during training) to calculate daily or bi-daily developmental competence probability values corresponding to zero to five days after fertilization and then calculate daily developmental competence probability values thereafter up to 10-12 days after fertilization.

Stage predictor 103 is configured to derive one or more stage probability values corresponding to an oocyte. Each stage probability value represents a probability of a corresponding embryo reaching a defined embryonic/developmental stage after oocyte fertilization and/or clinical stage after embryo transfer. In one aspect, for humans, stage predictor 103 derives a stage probability value for 2-cell stage, 4-cell stage, 8-cell stage, morula stage, early blastocyst stage, blastocyst stage, etc. That is, stage predictor 103 calculates a probability value for the corresponding embryo reaching a 2-cell stage, a probability value for the corresponding embryo reaching a 4-cell stage, . . . , and a probability value for the corresponding embryo reaching a blastocyst stage.

For humans, stage predictor 103 can also be configured (e.g., during training) to calculate stage probability values of clinical stages, such as, for example, biochemical pregnancy and implantation (also known as clinical pregnancy).

Across all mammalian species, embryo development varies significantly. As such, stage predictor 103 can be configured (e.g., during training) to calculate stage probability values for relevant/appropriate developmental and clinical stages tailored to a specific mammalian species.

The process of deriving developmental competence probabilities and stage probabilities can be repeated for other oocytes. Based on probabilities, oocytes can be ranked relative to one another. In general, oocyte selector 123 can select an oocyte (or oocytes) associated with a higher probability (or probabilities) of longer-term embryonic/fetal developmental competence and/or higher probability (or probabilities) of reaching later stages of embryonic development after fertilization and/or clinical development after embryo transfer.

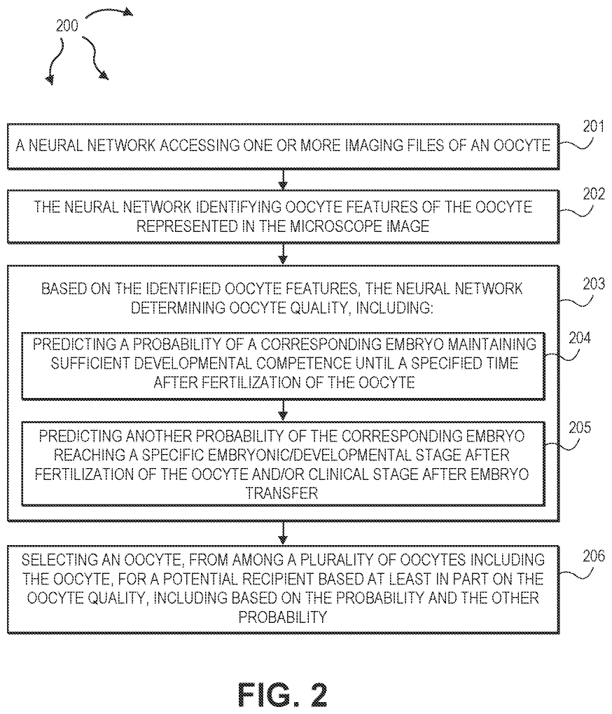

FIG. 2 illustrates a flow chart of an example method 200 for estimating oocyte quality and selecting an oocyte for fertilization. Method 200 will be described with respect to the components and data in computer architecture 100.

Image capture device 104 (e.g., part of a microscope) can capture image 111, including oocyte features, of oocyte 108. Oocyte features 112 can include morphological features of oocyte 108, medical/clinical characteristics of the oocytes source (e.g., patient/mother/oocyte donor), etc. In one aspect, oocyte 108 is a human oocyte. In another aspect, oocyte 108 is an oocyte of another mammalian species.

Method 200 includes a neural network accessing one or more imaging files of an oocyte (201). For example, neural network 101 can access image file 111. Method 200 includes the neural network identifying oocyte features of the oocyte represented in the microscope image(s) (202). For example, neural network 101 can identify oocyte features 112 from image 111. Method 200 includes, based on the identified oocyte characteristics, the neural network estimating oocyte quality (203). For example, neural network 101 can estimate oocyte quality 109 based on oocyte features 112.

Determining oocyte quality includes predicting a probability of a corresponding embryo maintaining sufficient developmental competence until a specified time after fertilization of the oocyte (204). For example, developmental competence predictor 102 can calculate developmental competence probabilities 121. Developmental competence probabilities 121 can include a developmental competence probability value for each of a plurality of defined time increments based on oocyte features 112. For example, for humans, health predictor 102 can calculate a health probability value for each day from 0 to 5 days after fertilization of oocyte 108. That is, health predictor 102 can calculate a probability value representing a probability of an embryo (resulting from fertilizing oocyte 108) being developmentally competent after one day, a probability value of the embryo being developmentally competent after two days, a probability value of the embryo being developmentally competent after three days, etc.

As described, developmental competence predictor 102 can calculate developmental competence probabilities over different time durations having different time increments/intervals for humans as well as other mammalian species.

Determining oocyte quality includes predicting another probability of the corresponding embryo reaching a specific embryonic/developmental stage after fertilization of the oocyte and/or clinical stage after embryo transfer (205). For example, stage predictor 103 can calculate stage probabilities 122. Stage probabilities 122 can include a stage probability value for each of a plurality of defined developmental and/or clinical stages based on oocyte features 112. For example, for humans, stage predictor 103 can calculate a stage probability value of a corresponding embryo reaching a 2-cell stage, a 4-cell stage, and 8-cell stage, a morula stage, an early blastocyst stage, a blastocyst stage, etc. after fertilization of oocyte 108. That is, stage predictor 103 can calculate a probability value representing a probability value of the corresponding embryo reaching a 2-cell stage, a probability value of the corresponding embryo reaching a 4-cell stage, a probability value of the corresponding embryo reaching an 8-cell stage, etc. In another aspect, stage predictor 103 calculates stage probability values of the corresponding embryo reaching various clinical stages.

As described, stage predictor 103 can calculate stage probabilities over other defined stages that are relevant/appropriate to humans as well as other mammalian species.

Oocyte quality 109 can include an identifier identifying oocyte 108, developmental competence probabilities 121, and stage probabilities 122. Turning to FIG. 1B, oocyte quality 109 can be included (e.g., stored) in oocyte data 111. Method 200 can be repeated for other oocytes (e.g., of the same species). Thus, qualities for other oocytes can also be derived and included (stored) in oocyte data 111. For example, oocyte data also includes oocyte quality 151 and oocyte quality 161. Oocyte quality 151 identifies oocyte 152 and includes developmental competence probabilities 153 and stage probabilities 154. Oocyte quality 161 identifies oocyte 162 and includes developmental competence probabilities 163 and stage probabilities 164.

Oocyte selector 123 can be configured to select one or more oocytes of higher quality oocytes from among the oocytes included in oocyte data 111. Higher quality oocytes can be selected (e.g., for fertilization), for example, as part of an in vitro fertilization (IVF) process or other assisted reproductive technology (ART) process.

Method 200 includes selecting an oocyte, from among a plurality of oocytes including the oocyte, for a potential recipient based at least in part on the oocyte quality, including based on the probability and the other probability (206). For example, oocyte selector 123 can select oocyte 108 from among oocyte data 111 based on quality 109, including based on health probabilities 121 and stage probabilities 122. Oocyte 108 can be selected as part of an in vitro fertilization (IVF) process or other assisted reproductive technology (ART) process for patient 107 (which may be a human or member of another mammalian species).

In one aspect, developmental competence probabilities 121 and stage probabilities 122 collectively represent that oocyte 108 is of higher quality than other oocytes included in oocyte data 111. That is, embryos resulting from fertilization of oocyte 108 have increased probability of longer-term developmental competence and/or have increased probability of reaching later developmental stages relative to embryos resulting from fertilization of other oocytes.

In another aspect, oocyte selector 123 selects oocyte 162 from among oocyte data 111 based on quality 161, including based on developmental competence probabilities 163 and stage probabilities 164. Oocyte 162 can be selected as part of an in vitro fertilization (IVF) process or other assisted reproductive technology (ART) process for patient 107. Developmental competence probabilities 163 and stage probabilities 164 can collectively represent that oocyte 162 is of higher quality than other oocytes included in oocyte data 111. That is, embryos resulting from fertilization of oocyte 162 have increased probability of longer-term developmental competence and/or have increased probability of reaching later developmental stages relative to embryos resulting from fertilization of other oocytes.

In a further aspect, oocyte selector 123 selects a plurality of higher quality oocytes, including oocytes 108 and 162, and potentially one or more other oocytes. For example, oocyte selector 123 can select ten to twenty oocytes as part of an in vitro fertilization (IVF) process or other assisted reproductive technology (ART) process for patient 107. The number of selected oocytes can vary per mammalian species, per individual, and per treatment cycle.

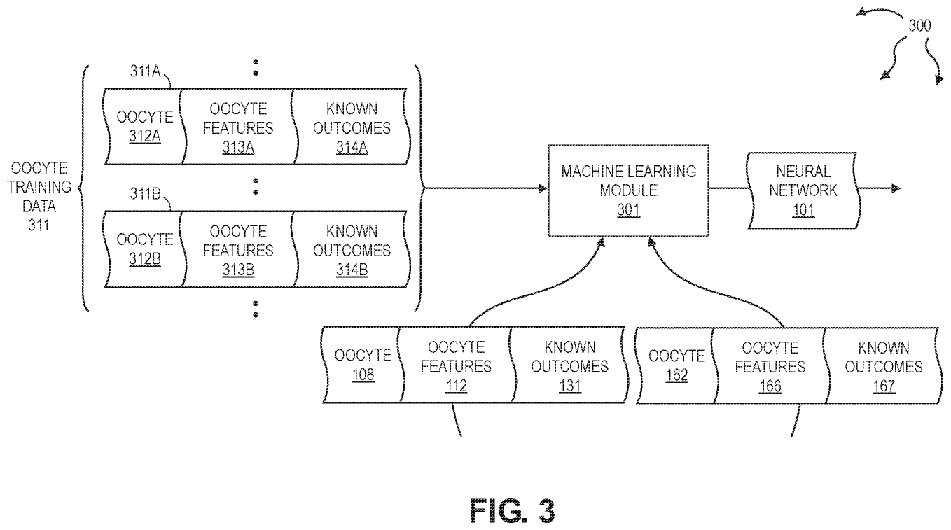

FIG. 3 illustrates an example computer architecture that 300 facilitates training a neural network to estimate oocyte quality.

As depicted, computer architecture 300 includes machine learning module 301. In general, machine learning module 301 can ingest oocyte training data (for a mammalian species, such as, humans) and utilize oocyte training data to train neural network 101 to derive oocyte quality (for the mammalian species). Oocyte training data can include oocyte features and known outcomes for a plurality of oocytes (e.g., hundreds, thousands, tens of thousands, or more oocytes). Known outcomes associated with an oocyte can include indications of embryo developmental competence over time durations, achievement of various embryonic stages for an embryo resulting from fertilization of the oocyte, and achievement of various clinical stages for a resulting embryo after embryo transfer. Through processing training data, machine learning module learns 301 combinations of oocyte features and medical/clinic features of an oocyte source (e.g., mother, donor, etc.) associated with longer-term embryonic developmental competence and appropriate developmental stage progression (for the mammalian species). Machine learning module 301 also learns combinations of oocyte features associated with reduced embryo developmental competence, halted embryo development, etc. (for the mammalian species).

Machine learning module 301 can train neural network 101 to assign higher qualities (e.g., higher probability values) to oocytes having features associated with longer-term developmental competence and appropriate embryonic/developmental/clinical stage progression. Machine learning module 310 can also train neural network 101 to assign lower quality (e.g., lower probability values) to oocytes having oocyte features associated with reduced embryo developmental competence, halted embryo development, etc.

In one aspect, machine learning module 301 initially trains neural network 101 using oocyte training data 311 (for a mammalian species, such as, humans). As depicted, oocyte training data 311 includes training data 311A, 311B, etc. per oocyte. For example, training data 311A is for oocyte 312A, having features 313A, with known outcomes 314A. Similarly, training data 311B is for oocyte 312B, having features 313B, with known outcomes 314B. Training data 311 can include training data for a plurality (e.g., hundreds, thousands, tens of thousands, etc.) of other oocytes. From training data 311, machine learning module 301 can learn combinations of oocyte features associated with longer-term embryonic developmental competence and appropriate embryonic stage progression (in the mammalian species). From training data 311, machine learning module 301 can also learn combinations of oocyte features associated with reduced embryo developmental competence, halted embryo development, etc. from oocyte training data 311 (in the mammalian species).

Machine learning module 301 can train neural network 101 to assign higher qualities (e.g., higher probability values) to oocytes having features learned from oocyte training data 311 that are associated with longer-term embryonic developmental competence and appropriate embryonic stage progression. Machine learning module 310 can also train neural network 101 to assign lower quality (e.g., lower probability values) to oocytes having oocyte features learned from oocyte training data 311 that are associated with reduced embryo developmental competence, halted embryo development, etc.

Machine learning module 301 can also update neural network 101 as further training data becomes available. For example, an (IVF) process or other assisted reproductive technology (ART) process associated with patient 107 can be monitored. As such, outcomes associated with fertilization of oocyte 108 and/or fertilization of oocyte 162 can be known. Machine learning module 301 can use these additional known outcomes to refine neural network 101.

For example, machine learning module 301 can receive oocyte 108, oocyte features 112, and known outcomes 131. Known outcomes 131 can indicate developmental competence of a corresponding embryo (resulting from fertilization of oocyte 108) over time and the corresponding embryo's progression through various embryonic stages. Similarly, machine learning module 301 can receive oocyte 162, oocyte features 166 (of oocyte 162), and known outcomes 167. Known outcomes 167 can indicate developmental competence of a corresponding embryo (resulting from fertilization of oocyte 167) over time and the corresponding embryo's progression through various embryonic stages.

Machine learning module 301 can refine neural network 101 based on features 112/known outcomes 131 and/or features 166/known outcomes 167. Thus, over time the precision and accuracy of neural network 101's quality estimations can continual improve.

In one aspect, neural network 101 is a Convolutional Neural Network (CNN).

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (SSDs) (e.g., RAM-based or Flash-based), Shingled Magnetic Recording (SMR) devices, storage class memory (SCM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: oocyte identifiers, oocyte images, oocyte features, oocyte quality, developmental competence probabilities, stage probabilities, selected oocytes, oocyte training data, known outcomes, neural networks, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, oocyte identifiers, oocyte images, oocyte features, oocyte quality, developmental competence probabilities, stage probabilities, selected oocytes, oocyte training data, known outcomes, neural networks, etc.

Implementations of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as on premise, private cloud, community cloud, public cloud, hybrid cloud, and so forth. In this description and in the following claims, a “cloud computing environment” is an environment in which cloud computing is employed.

Hybrid cloud deployment models combine portions of other different deployment models, such as, for example, a combination of on premise and public, a combination of private and public, a combination of two different public cloud deployment models, etc. Thus, resources utilized in a hybrid cloud can span different locations, including on premise, private clouds, (e.g., multiple different) public clouds, etc.

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising:
a neural network accessing a one or more image files of an oocyte;
the neural network identifying oocyte features of the oocyte represented in the microscope image;
based on the identified oocyte features, the neural network estimating oocyte quality, including:
predicting a probability of a corresponding embryo maintaining sufficient developmental competence until a specified time after fertilization of the oocyte; and
predicting another probability of the corresponding embryo reaching a specific embryonic stage after fertilization of the oocyte; and
selecting an oocyte, from among a plurality of human oocytes including the human oocyte, for a potential recipient based at least in part on the oocyte quality, including based on the probability and the other probability.

2. The method of claim 1, wherein accessing a microscopic image of an oocyte comprises accessing a microscopic image of an unfertilized oocyte.

3. The method of claim 1, wherein accessing a microscopic image of an oocyte comprises accessing a microscopic image of a human oocyte.

4. The method of claim 1, wherein identifying oocyte characteristics comprises identifying morphological characteristics of the oocyte.

5. The method of claim 1, wherein predicting a probability of the oocyte maintaining sufficient developmental competence until a specified time after fertilization comprises predicting the probability of the oocyte maintaining sufficient health for a specified number of days after fertilization.

6. The method of claim 1, wherein predicting another probability of the human oocyte reaching a specific embryonic stage comprises predicting the other probability of the human oocyte reaching one of: a 2-cell stage, a 4-cell stage, an 8-cell stage, a morula stage, an early blastocyst stage, or a blastocyst stage.

7. The method of claim 1, wherein accessing a microscopic image of an oocyte comprises accessing an oocyte of a specific mammalian species.

8. The method of claim 7, wherein predicting a probability of a corresponding embryo maintaining sufficient developmental competence until a specified time comprises predicting the probability of the corresponding embryo maintaining sufficient developmental competence until the specified time tailored based on the specific mammalian species.

9. The method of claim 7, wherein predicting another probability of the corresponding embryo reaching a specific embryonic stage comprises predicting the other probability of the corresponding embryo reaching the specific embryonic stage tailored based on the specific mammalian species.

10. A system comprising:
a processor; and
system memory coupled to the processor and storing instructions configured to cause the processor to:
at a neural network:
access a one or more image files of an oocyte;
identify oocyte features of the oocyte represented in the microscope image;
based on the identified oocyte features, estimate oocyte quality, including:
predict a probability of a corresponding embryo maintaining sufficient developmental competence until a specified time after fertilization of the oocyte; and
predict another probability of the corresponding embryo reaching a specific embryonic stage after fertilization of the oocyte; and
select an oocyte, from among a plurality of human oocytes including the human oocyte, for a potential recipient based at least in part on the oocyte quality, including based on the probability and the other probability.

11. The system of claim 10, wherein instructions configured to access a microscopic image of an oocyte comprise instructions configured to access a microscopic image of an unfertilized oocyte.

12. The system of claim 10, wherein instructions configured to access a microscopic image of an oocyte comprise instructions configured to access a microscopic image of a human oocyte.

13. The system of claim 10, wherein instructions configured to identify oocyte characteristics comprise instructions configured to identify morphological characteristics of the oocyte.

14. The system of claim 10, wherein instructions configured to predict a probability of the oocyte maintaining sufficient developmental competence until a specified time after fertilization comprise instructions configured to predict the probability of the oocyte maintaining sufficient developmental competence for a specified number of weeks after fertilization.

15. The system of claim 10, wherein instructions configured to predict another probability of the human oocyte reaching a specific embryonic stage comprise instructions configured to predict the other probability of the human oocyte reaching one of: a 2-cell stage, a 4-cell stage, an 8-cell stage, a morula stage, an early blastocyst stage, or a blastocyst stage.

16. The system of claim 10, wherein instructions configured to accessing a microscopic image of an oocyte comprises instructions configured to access an oocyte of a specific mammalian species.

17. The system of claim 16, wherein instructions configured to predict a probability of a corresponding embryo maintaining sufficient developmental competence until a specified time comprise instructions configured to predict the probability of the corresponding embryo maintaining sufficient developmental competence until the specified time tailored based on the specific mammalian species.

18. The system of claim 16, wherein instructions configured to predict another probability of the corresponding embryo reaching a specific embryonic stage comprise instructions configured to predict the other probability of the corresponding embryo reaching the specific embryonic stage tailored based on the specific mammalian species.
